(19) United States
(12) Patent Application Publication
(10) Pub. No.: US 2026/0148461 A1
(43) Pub. Date: May 28, 2026

(54) METHOD AND APPARATUS FOR RECONSTRUCTING MULTIVIEW MULTI-PERSON AVATAR

(71) Applicant: Electronics and Telecommunications Research Institute, Daejeon (KR)

(72) Inventors: Hee Kyung LEE, Daejeon (KR); Soo Hyun LEE, Seoul (KR); Joo Ho LEE, Seoul (KR); Seo Yeon KIM, Seoul (KR)

(73) Assignee: Electronics and Telecommunications Research Institute, Daejeon (KR)

(21) Appl. No.: 19/393,728

(22) Filed: Nov. 19, 2025

(30) Foreign Application Priority Data
Nov. 27, 2024 (KR) 10-2024-0172882
Nov. 10, 2025 (KR) 10-2025-0168673

(51) Int. Cl. G06T 13/40; G06T 3/4038; G06T 7/60; G06T 7/70

(52) U.S. Cl. CPC G06T 13/40; G06T 3/4038; G06T 7/60; G06T 7/70; G06T 2207/20081; G06T 2207/30196

(57) ABSTRACT

A method for reconstructing multi-person object avatars based on a planar Gaussian model, comprising: receiving one or more images captured at one or more viewpoints, estimating poses of at least two human objects from each frame of the one or more images; estimating geometric information of the at least two human objects using a monocular viewpoint information inference model; representing a shape and appearance of each human object in a target frame for at least two human objects by using the planar Gaussian model; generating a synthetic image by rendering the at least two human objects; performing learning on the at least two human objects based on the generated synthetic image; and reconstructing final human object avatar meshes for each human object based on a result of the learning.

### CROSS REFERENCE TO RELATED APPLICATIONS

This application claims the benefit of earlier filing date and right of priority to Korean Application No. 10-2024-0172882, filed on Nov. 27, 2024, Korean Application No. 10-2025-0168673, filed on Nov. 10, 2025, the contents of which are all hereby incorporated by reference herein in their entirety.

### TECHNICAL FIELD

The present disclosure relates to a method for reconstructing multi-object avatars from multiple viewpoints and an apparatus for performing the same. More specifically, the present disclosure relates to a method for implementing an object surface capable of clear inside-out testing in an avatar representation method based on a planar Gaussian model, and an apparatus for performing the same.

### BACKGROUND

Multi-view person multi-object avatar reconstruction is a method for reconstructing the movement, geometry, and appearance of individual human objects from multi-view video. With the rapidly increasing demand for realistic content such as the metaverse and AR/VR, the importance of 3D avatar technology, which naturally recreates the figure of real people in digital spaces, is increasing. Especially in the metaverse environment, where multiple users interact simultaneously, multi-view multi-object avatar reconstruction technology, which can naturally reconstruct the figure of multiple people in real time, is essential.

Avatar reconstruction techniques generally involve capturing multiple viewpoints of a single object to create a 3D model. This method involves extracting depth information from images captured by multiple cameras, generating a 3D mesh based on this information, and then applying textures. However, this method may make accurate 3D reconstruction difficult due to object occlusion when multiple objects are present. Furthermore, the accuracy of simultaneously tracking and reconstructing multiple moving objects may be reduced.

Intrinsic function-based human object reconstruction methods utilize massive human object video data and mapped human object data to directly infer the geometry and/or texture of an avatar via a network. Because this method relies on learning, it can require a very large amount of data and training volume to achieve generalized performance. Furthermore, the quality of the generated avatars may be poor when representing new human objects. To apply this to multi-person objects, the object area of each human may be detected and only the images corresponding to each object may be input into the network to reconstruct the 3D geometry and/or texture. This approach can lead to penetration (interpenetration) because objects are created independently.

The ray-based volume rendering avatar reconstruction method may refer to a method that learns the representation method by volume-rendering a density-based ray field representation along each camera ray and comparing the rendered values with observed values. Unlike intrinsic function-based human object reconstruction methods, this method does not require extensive training data, but only observation information about the dynamic scene to be reconstructed. This method can vary significantly in accuracy and operation time depending on the number of viewpoints and scenes.

While volume-rendered avatar reconstruction methods based on 3D Gaussian models offer the advantages of real-time rendering and rapid learning, there is also a limitation that ordering with the actual surface is inaccurate. The method can be processed by warping camera rays into a reference space while learning the density-based radiance field within the volume. This process makes it difficult to clearly separate geometric shapes and textures, potentially resulting in physically inaccurate surface geometries. Additionally, because it is a volume-based approach rather than a surface-based shape reconstruction, it has difficulty in accurately reconstructing object boundaries or thin structures (e.g., fingers), and these limitations may become more pronounced in multi-object environments.

### SUMMARY

The object of the present disclosure is to provide a method for performing layer-based rendering per human object for multiple human objects.

It is a further object of the present disclosure to provide a method for performing rendering of multiple human objects in a single volume space.

It is a further object of the present disclosure to provide a method for performing rendering by applying a see-through effect in a layer-based rendering method for each human object.

It is a further object of the present disclosure to provide a method for inferring geometric/object information of a human object using a monocular view information inference model.

It is a further object of the present disclosure to provide a method for learning the shape and/or appearance of a human object using the results of monocular viewpoint inference.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for reconstructing multi-person object avatars based on a planar Gaussian model, comprising: receiving one or more images captured at one or more viewpoints; estimating poses of at least two human objects from each frame of the one or more images; estimating geometric information of the at least two human objects using a monocular viewpoint information inference model; representing a shape and appearance of each human object in a target frame for at least two human objects by using the planar Gaussian model; generating a synthetic image by rendering the at least two human objects; performing learning on the at least two human objects based on the generated synthetic image; and reconstructing final human object avatar meshes for each human object based on a result of the learning, wherein the synthetic image is generated by blending human object layers for the at least two human objects, and wherein the human object layers are individually generated for the at least two human objects ordered based on depth values.

In the method for for reconstructing multi-person object avatars based on a planar Gaussian model according to the present disclosure, wherein the synthetic image is generated based on at least one map of alpha map, a color map, a depth map, and a normal map for each human object.

In the method for reconstructing multi-person object avatars based on a planar Gaussian model according to the present disclosure, wherein the blending is performed by considering a blending weight, and wherein the blending weight is determined based on the alpha value of the human object and the depth difference between the human objects.

In the method for reconstructing multi-person object avatars based on a planar Gaussian model according to the present disclosure, wherein the at least two human objects are positioned in close proximity, semi-transparent rendering is performed.

In the method for reconstructing multi-person object avatars based on a planar Gaussian model according to the present disclosure, wherein the learning is performed by adaptively adjusting a predetermined hyperparameter, wherein the predetermined hyperparameter is a parameter that controls sensitivity to depth differences between human objects.

In the method for reconstructing multi-person object avatars based on a planar Gaussian model according to the present disclosure, wherein the learning is performed based on a loss function including at least one of a photometric reconstruction loss term, a surface ordering loss term, and a monocular view geometric loss term, wherein the monocular view geometric loss term includes at least one of a depth loss term and a normal loss term.

In the method for reconstructing multi-person object avatars based on a planar Gaussian model according to the present disclosure, wherein the learning is performed based on a loss function that further includes at least one of a basic regularization term and a GART additional regularization term, wherein the GART additional regularization term is a regularization term that integrates a KNN-based smoothing term and a spatial distortion regularization term.

In the method for reconstructing multi-person object avatars based on a planar Gaussian model according to the present disclosure, wherein the shape in the target frame is represented using the planar Gaussian model, wherein the planar Gaussian model is represented as a distribution function of at least one of a rotation, center position, and scale matrix.

In the method for reconstructing multi-person object avatars based on a planar Gaussian model according to the present disclosure, wherein the appearance in the target frame is represented via linear blending skinning, wherein the linear blending skinning is a technique for defining a transformation between a reference space in which the poses of the at least two human objects are modeled and a target space to which movement is applied.

In the method for reconstructing multi-person object avatars based on a planar Gaussian model according to the present disclosure, wherein the method further includes refining the estimated poses of the at least two human objects.

In the method for reconstructing multi-person object avatars based on a planar Gaussian model according to the present disclosure, wherein a number of the received one or more images is N (4≤N≤8).

In accordance with an aspect of the present disclosure, the above and other objects can be accomplished by the provision of an apparatus for reconstructing multi-person object avatars based on a planar Gaussian model, comprising: one or more transceivers; one or more memories; and one or more processors, the one or more processors being configured to: receive one or more images captured at one or more viewpoints, estimate poses of at least two human objects from each frame of the one or more images, estimate geometric information of the at least two human objects using a monocular viewpoint information inference model, represent a shape and appearance of each human object in a target frame for at least two human objects by using the planar Gaussian model, generate a synthetic image by rendering the at least two human objects, perform learning on the at least two human objects based on the generated synthetic image, and reconstruct final human object avatar meshes for the at least two human objects based on a result of the learning, wherein the synthetic image is generated by blending human object layers for the at least two human objects, and wherein the human object layers are individually generated for the at least two human objects ordered based on depth values.

In accordance with an aspect of the present disclosure, the above and other objects can be accomplished by the provision of a method for reconstructing multi-person object avatars based on a planar Gaussian model, comprising: receiving one or more images captured at one or more viewpoints; estimating poses of at least two human objects from each frame of the one or more images; estimating geometric information of the at least two human objects using a monocular viewpoint information inference model; representing a shape and appearance of each human object in a target frame for at least two human objects by using the planar Gaussian model; generating a synthetic image by rendering the at least two human objects; performing learning on the at least two human objects based on the generated synthetic image; and reconstructing final human object avatar meshes for each human object based on a result of the learning, wherein the synthetic image is generated by projecting the at least two human objects ordered based on depth values into a single image space.

In the method for reconstructing multi-person object avatars based on a planar Gaussian model according to the present disclosure, wherein the learning is performed based on a loss function including at least one of a photometric reconstruction loss term, a surface ordering loss term, and a monocular view geometric loss term, wherein the monocular view geometric loss term includes at least one of a depth loss term and a normal loss term.

In the method for reconstructing multi-person object avatars based on a planar Gaussian model according to the present disclosure, wherein the learning is performed based on a loss function that further includes at least one of a basic regularization term and a GART additional regularization term, wherein the GART additional regularization term is a regularization term that integrates a KNN-based smoothing term and a spatial distortion regularization term.

In the method for reconstructing multi-person object avatars based on a planar Gaussian model according to the present disclosure, wherein the shape in the target frame is represented using the planar Gaussian model, wherein the planar Gaussian model is represented as a distribution function of at least one of a rotation, center position, and scale matrix.

In the method for reconstructing multi-person object avatars based on a planar Gaussian model according to the present disclosure, wherein the appearance in the target frame is represented via linear blending skinning, wherein the linear blending skinning is a technique for defining a transformation between a reference space in which the poses of the at least two human objects are modeled and a target space to which movement is applied.

In the method for reconstructing multi-person object avatars based on a planar Gaussian model according to the present disclosure, wherein the method further includes refining the estimated poses of the at least two human objects.

In the method for reconstructing multi-person object avatars based on a planar Gaussian model according to the present disclosure, wherein a number of the received one or more images is N (4≤N≤8).

In accordance with an aspect of the present disclosure, the above and other objects can be accomplished by the provision of an apparatus for reconstructing multi-person object avatars based on a planar Gaussian model according to the present disclosure, comprising: receive one or more images captured at one or more viewpoints, estimate poses of at least two human objects from each frame of the one or more images, estimate geometric information of the at least two human objects using a monocular viewpoint information inference model, represent a shape and appearance of each human object in a target frame for at least two human objects by using the planar Gaussian model, generate a synthetic image by rendering the at least two human objects, perform learning on the at least two human objects based on the generated synthetic image, and reconstruct final human object avatar meshes for each human object based on a result of the learning, wherein the synthetic image is generated by projecting the at least two human objects ordered based on depth values into a single image space.

The features briefly summarized above regarding the present disclosure are merely exemplary aspects of the detailed description of the present disclosure that follows and do not limit the scope of the present disclosure.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart illustrating a method for reconstructing multi-person object avatars based on a planar Gaussian model according to one embodiment of the present disclosure.

FIG. 2 is drawing showing an example of modeling a human object using a planar Gaussian model according to the present disclosure.

FIG. 3 is a diagram schematically illustrating a differentiable layer rendering process according to one embodiment of the present disclosure.

FIG. 4 is a diagram schematically illustrating a learning process of a rendered image according to one embodiment of the present disclosure.

FIG. 5 is a flowchart of a method for reconstructing multi-person object avatars based on a planar Gaussian model according to one embodiment of the present disclosure.

FIG. 6 is a block diagram of an apparatus for reconstructing multi-person object avatars based on a planar Gaussian model according to one embodiment of the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

In the present disclosure, the terms “person” and “human” may be used interchangeably to refer to the same concept.

Multi-view person multi-object avatar reconstruction is a method for reconstructing the movement, geometry, and appearance of individual human objects from multi-view video. With the rapidly increasing demand for realistic content such as the metaverse and AR/VR, the importance of 3D avatar technology, which naturally recreates the figure of real people in digital spaces, is increasing. Especially in the metaverse environment, where multiple users interact simultaneously, multi-view multi-object avatar reconstruction technology, which can naturally reconstruct the figure of multiple people in real time, is essential.

Avatar reconstruction techniques generally involve capturing multiple viewpoints of a single object to create a 3D model. This method involves extracting depth information from images captured by multiple cameras, generating a 3D mesh based on this information, and then applying textures. However, this method may make accurate 3D reconstruction difficult due to object occlusion when multiple objects are present. Furthermore, the accuracy of simultaneously tracking and reconstructing multiple moving objects may be reduced.

Intrinsic function-based human object reconstruction methods utilize massive human object video data and mapped human object data to directly infer the geometry and/or texture of an avatar via a network. Because this method relies on learning, it can require a very large amount of data and training volume to achieve generalized performance. Furthermore, the quality of the generated avatars may be poor when representing new human objects. To apply this to multi-person objects, the object area of each human may be detected and only the images corresponding to each object may be input into the network to reconstruct the 3D geometry and/or texture. This approach can lead to penetration because objects are created independently.

The ray-based volume rendering avatar reconstruction method may refer to a method that learns the representation method by volume-rendering a density-based ray field representation along each camera ray and comparing the rendered values with observed values. Unlike intrinsic function-based human object reconstruction methods, this method does not require extensive training data, but only observation information about the dynamic scene to be reconstructed. This method can vary significantly in accuracy and operation time depending on the number of viewpoints and scenes.

While volume-rendered avatar reconstruction methods based on 3D Gaussian models offer the advantages of real-time rendering and rapid learning, there is also a limitation that ordering with the actual surface is inaccurate. The method can be processed by warping camera rays into a reference space while learning the density-based radiance field within the volume. This process makes it difficult to clearly separate geometric shapes and textures, potentially resulting in physically inaccurate surface geometries. Additionally, because it is a volume-based approach rather than a surface-based shape reconstruction, it has difficulty in accurately reconstructing object boundaries or thin structures (e.g., fingers), and these limitations may become more pronounced in multi-object environments.

The present disclosure aims to provide a technique for reconstructing multiple human avatars from sparse multi-view images, estimating the geometrically accurate appearance of the avatars and improving the rendering quality, while solving the inter-penetration problem to accurately maintain the geometric relationship between avatars.

Specifically, the present disclosure seeks to implement a geometrically accurate surface that enables clear inside-out testing via an avatar representation method based on a planar Gaussian Splat model.

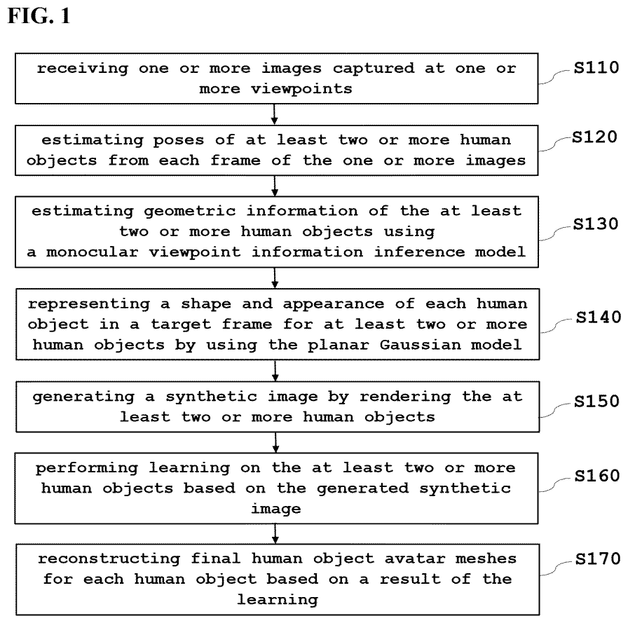

FIG. 1 is a flowchart illustrating a method for reconstructing multi-person object avatars based on a planar Gaussian model according to one embodiment of the present disclosure.

Referring to FIG. 1, one or more images captured at one or more viewpoints are received S110.

According to one embodiment of the present disclosure, images captured at one or more viewpoints may be received. The number of input images may be one or more. The input images can be data that has undergone camera calibration and synchronization.

Referring to FIG. 1, poses of at least two human objects are estimated from each frame of the one or more images S120.

According to one embodiment of the present disclosure, the poses of multiple human objects may be estimated using a human template model (e.g., SMPL, SMPLX, etc.) in each frame of an image for one or more viewpoints. The poses of human object may be estimated by estimating keypoints of human object in each frame.

Referring to FIG. 1, geometric information of the at least two human objects is estimated using a monocular viewpoint information inference model S130.

According to one embodiment of the present disclosure, a monocular view information inference model may be used to estimate geometric characteristics from a single-view image. Specifically, the monocular view information inference model may be used to obtain depth information, surface normal information, or instance segmentation information of an object.

According to one embodiment of the present disclosure, refinement of the estimated poses of the at least two human objects may be performed.

According to one embodiment of the present disclosure, refinement of the initial pose estimated in S120 may be performed using a 3D pose model of a human object (e.g., SMPL, SMPLX, etc.). This is to improve accuracy.

Specifically, a 3D pose model of a human object may be projected at each viewpoint, and the projected image and the instance segmentation inferred by the monocular view information inference model may be verified pixel by pixel to ensure consistency. Pose learning and refinement may be performed to ensure consistency between the projected image and the instance segmentation.

Referring to FIG. 1, a shape and appearance of each human object in a target frame for at least two human objects is represented by using the planar Gaussian model S140.

The process may correspond to a process performed to reconstruct a geometrically consistent 3D avatar surface by clarifying the inner and outer boundaries of the avatar and to detect physically unnatural phenomena such as petetration between objects.

According to one embodiment of the present disclosure, an avatar for at least two human objects may be expressed based on a planar Gaussian model, and the shape and appearance of each human object may be modeled in an independent reference space. Interpolation may also be performed on the modeled human objects. Specifically, the shape or position of the surrounding space may be interpolated via the transformation (or coordinate transformation) of the major joints of the human object, thereby expressing realistic movements.

The planar Gaussian model used in the present disclosure may also be referred to as a planar Gaussian mixture appearance model.

According to one embodiment of the present disclosure, a planar Gaussian model linked to a human body template model (e.g., SMPL, SMPLX, etc.) may be used in the planar Gaussian mixture appearance model.

Here, the planar Gaussian model may refer to a set of planar Gaussians, each of which may be distributed in the canonical space of a human object. Furthermore, the canonical space may refer to an independent space where each avatar assumes a canonical human pose, called DA-pose.

Each planar Gaussian model may be represented by parameters of a rotation (R), a center position (t), and/or a scale matrix(S). More specifically, the spatial density distribution Gᵢ of the planar Gaussian model may be represented by a distribution function in the form of the following mathematical equation 1.

$${G}_{i} ( u ) = exp ( - 1 / 2 * {u}^{T} * {S}_{i}^{( - T )} {S}_{i}^{( - 1 )} * u ) \qquad [ Mathematical equation 1 ]$$

Here, i may represent the index of the planar Gaussian model, and u may represent the local 2D coordinates (u, v) of the ith planar Gaussian model. The local 2D coordinates may be converted to 3D coordinates x=Ru+t. Sᵢ may represent the scale matrix of the ith Gaussian.

The surface attribute representation of the planar Gaussian model may include viewpoint-dependent color (c), opacity (α), and/or surface normal (n). The geometric and radiometric appearances may be expressed via the surface attribute representation.

According to one embodiment of the present disclosure, a transformation to a specific viewpoint may be performed to represent an appearance in a target frame, and the transformation to the specific viewpoint can be performed specifically as follows.

For example, transformation to a specific viewpoint may be performed by using linear blending skinning (LBS).

Linear blending skinning may be defined as a technique that smoothly connects the reference space and the target space by defining a transformation between the reference space where the initial pose of the object is modeled and the target space where the movement is applied. Linear blending skinning handles spatial deformations via linear combinations of human joint transformations. This means that spatial deformations may be handled by calculating how each point in the model is affected by the movements of multiple human joints via weighted linear combinations. Complex motions, such as the wrinkling or stretching of clothing, may be implemented by additionally applying auxiliary deformation fields.

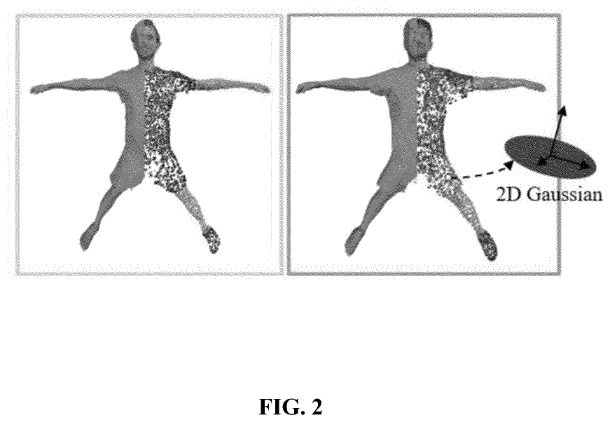

FIG. 2 is drawing showing an example of modeling a human object using a planar Gaussian model according to the present disclosure.

Referring to FIG. 2, an avatar for at least two human objects may be expressed based on the above-mentioned planar Gaussian model, and the shape and appearance of each human object may be modeled in an independent reference space.

The shape and appearance of each human object may be modeled using the mathematical equation 1 described above. The surface attribute representation of the planar Gaussian model may include viewpoint-dependent color (c), opacity (α), and/or surface normal (n).

Interpolation may also be performed on the modeled human objects. Specifically, the shape or position of the surrounding space may be interpolated via the transformation (or coordinate transformation) of the major joints of the human object, thereby expressing realistic movements.

Referring to FIG. 1, a synthetic image is generated by rendering the at least two human objects S150.

This disclosure proposes two rendering methods (a first rendering method and a second rendering method). Below, the first rendering method of this disclosure will be examined in detail.

### Human Object Layer Rendering Method (A First Rendering Method)

For each frame, the representation of a human object is transformed to match the pose of the frame at a specific point in time. Each human object may be rendered in a separate layer (human object layer) for at least two human objects. The rendered layers are combined to create a synthetic image, which may include depth, normal, and/or color images. A Gaussian model may be trained to ensure that the generated synthetic image matches information inferred from a monocular viewpoint.

More specifically, the human object layer rendering method is as follows.

According to one embodiment of the present disclosure, for each human object, a Gaussian model of an avatar moved from a reference space to a target space is ordered based on depth, projected into an independent image space, and the final avatar appearance is rendered to generate a layer for each human object. A specific formula may be expressed as mathematical equation 2 below.

$$[ Mathematical equation 2 ]$$

$$p ( r ) = {Σ}_{( i = 1 )} {p}_{i} * {α}_{i} * {G}_{i} ( {u}_{i} ( r ) ) * {Π}_{( j = 1 to i - 1 )} ( 1 - {α}_{j} * {G}_{j} ( {u}_{j} ( r ) ) )$$

Here, r may represent a pixel ray, and i may represent an index of a planar Gaussian model. pᵢ ∈{cᵢ (r), nᵢ, dᵢ} may represent attributes of the planar Gaussian model. The attributes may include color, normal, and/or depth. αᵢ may represent the opacity of the planar Gaussian model. Gᵢ may represent the spatial density distribution of the ith planar Gaussian model, and uᵢ (r) may represent the intersection of the ray and the model.

As described above, the spatial density distribution Gᵢ of each planar Gaussian model may be calculated as in the above-mentioned mathematical equation 1.

According to one embodiment of the present disclosure, an alpha map αₒ (x), a color map cₒ (x), a depth map dₒ (x), and/or a normal map nₒ (x) may be generated for a human object o at pixel location x. This independent map generation process may play an important role in preventing information confusion between objects and accurately preserving the characteristics of each object.

According to one embodiment of the present disclosure, a single multi-person image may be synthesized by blending the layers of each human object via layer alpha blending. In areas where multiple person objects overlap, a sophisticated blending process based on depth values may be performed. The final blended color value c_{blend}(x) may be calculated as a weighted sum of the color values of each object and the blending weight, as shown in the following mathematical equation 3.

$$[ Mathematical equation 3 ]$$

$${c}_{blend} ( x ) = {Σ}_{( o = 1 to no )} {ω}_{o} ( x ) {c}_{o} ( x ) {Π}_{( p = 1 to o - 1 )} ( 1 - {ω}_{p} ( x ) )$$

Here, nₒ may represent the total number of objects, ωₒ may represent the blending weight of object o, and cₒ (x) may represent the color value of the object. The blending weight ωo(x) of each object may be determined by considering the alpha value and depth difference of the object, as shown in the following mathematical equation 4.

$$[ Mathematical equation 4 ]$$

$${ω}_{o} ( x ) = {α}_{o} ( x ) / ( 1 + exp \{ - s ( {d}_{o} ( x ) - {d}_{o + 1} ( x ) ) \} )$$

Here, s may represent a hyperparameter that controls sensitivity to depth differences.

A weight calculation method like Mathematical equation 4 may effectively handle overlap by naturally reflecting depth differences between objects.

Meanwhile, in the human object layer rendering method of the present disclosure, a synthetic image may be generated by using a depth-based see-through effect application method in the blending weight calculation process.

Depth-based see-through effects may be applied to solve the interpenetration problem that occurs in close contact areas by introducing a see-through effect based on depth differences. The see-through effect is a phenomenon in which a back layer is visible through a front layer, and may refer to a visual effect in which objects appear semi-transparent rather than opaque. The depth-based see-through effect may be applied by reflecting the depth difference in the blending weight calculation process, enabling semi-transparent visualization when objects are close together and general opaque rendering when objects are far apart.

Specifically, when two objects are very close together, the blending weight will have a value close to 0.5 αₒ (x), which may produce a semi-transparent effect. This is very effective for visualizing and modifying penetrated body parts. Conversely, when the objects are sufficiently far apart, the blending weight will have a value close to αₒ (x), which may result in general opaque rendering.

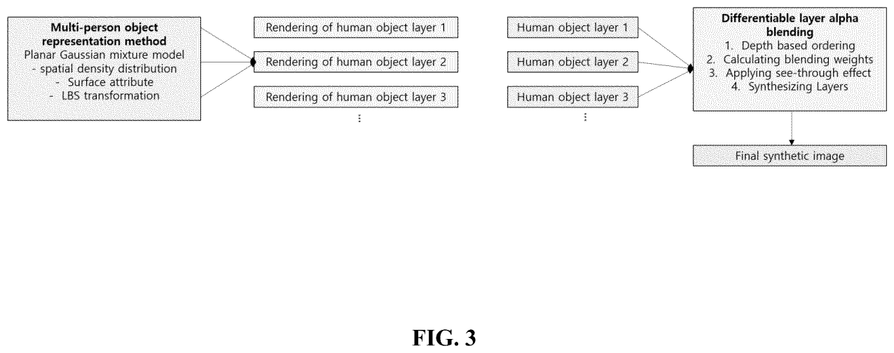

FIG. 3 is a diagram schematically illustrating a differentiable layer rendering process according to one embodiment of the present disclosure.

Referring to FIG. 3, as discussed in S140, the shape and appearance of at least two human objects may be expressed in the target frame for each human object using a planar Gaussian model. The expressed shape and appearance may also be understood as a representation method of the human object.

According to one embodiment of the present disclosure, a planar Gaussian model may represent a shape in a reference space in the form of a distribution function of at least one of a rotation, center position, and scale matrix. In addition, the shape and appearance of each human object in a target frame may be represented via LBS transformation. Since the spatial density distribution and/or surface attribute expression of the planar Gaussian model of the present disclosure are the same as those discussed in S140, a detailed description thereof will be omitted here.

Referring to FIG. 3, for at least two human objects (e.g., human object 1, human object 2, human object 3, etc.), each human object may be independently rendered to a different layer to create at least two human object layers (e.g., human object layer 1, human object layer 2, human object layer 3, etc.).

Referring to FIG. 3, a final synthetic image may be generated by applying the differentiable layer alpha blending proposed in the present disclosure to the generated layer. The differentiable layer alpha blending proposed in the present disclosure may be characterized by depth-based ordering of layers, calculation of blending weights, application of a see-through effect based on depth differences, and synthesis of multiple layers, as described above. As these have been discussed in detail above, a detailed description thereof will be omitted here.

Referring to FIG. 1, performing learning on the at least two human objects based on the generated synthetic image S160.

All visible avatars may be rendered as video frames in the same manner as described in step S150.

According to one embodiment of the present disclosure, learning may be performed for at least two human objects based on a rendered synthetic image.

For example, learning may be performed by applying a penalty for luminance differences.

For example, learning may be performed using inference results from a monocular view information inference model. The inference results may include instance segmentation using the monocular view information inference model and/or geometric information estimated using the monocular view information inference model.

For example, when a human object layer rendering method is used, learning may be performed by applying adaptive adjustments during the optimization process.

The optimization process may refer to the process of updating the parameters of a Gaussian model (including Gaussian parameters and/or pose parameters) using a loss function. In other words, it can refer to a process that involves iteratively calculating the loss function and updating the parameters.

Adaptive adjustment during the optimization process can control the see-through effect by gradually adjusting the hyperparameter s during the learning process. In the initial learning phase of adaptive adjustment during the optimization process, small values of s are used to insensitively adjust depth differences, making it easier to detect and correct interpenetration problems. As learning progresses, the value of s can be gradually increased to converge to opaque rendering.

This stepwise adjustment may initially effectively resolve penetration issues through a wide range of see-through effects, and later enable high-quality rendering in areas where precise depth relationships are established. Consequently, the method of the present disclosure may effectively resolve overlap and interpenetration issues that arise when rendering multi-person 3D avatars.

In the present disclosure, the loss function is configured to include at least one of the following loss terms, and the overall loss function may be defined as a weighted sum of these.

### 1. Photometric Reconstruction Loss

The photometric reconstruction loss measures the difference between the rendered image and the actual input image and may be defined as in the following mathematical equation 5.

$$[ Mathematical equation 5 ]$$

$${L}_{c} = Σ ( r ∈ R ) {‖ c ( r ) - \hat{c} ( r ) ‖}_{1} + {λ}_{SSIM} \cdot SSIM ( Ck , \hat{C} k )$$

Here, r may represent a pixel (or ray), R may represent a set of pixels in the optimization process, ĉ(⋅) may represent the observed pixel value, and λ_{SSIM} may represent a linear coefficient. SSIM( ) may represent the SSIM (Structural Similarity Index Measure) loss function, and Ck and Ċk may represent the k-th rendered image and the observed (actual input) image, respectively.

### 2. Surface Ordering Loss

The surface ordering loss may utilize the instance segmentation map as a surface visibility map to clarify the boundaries between avatars and prevent incorrect depth order of surfaces, and may be defined as in the following mathematical equation 6 by applying the cross entropy loss.

$$[ Mathematical equation 6 ]$$

$${L}_{so} = - Σ ( r ∈ R ) Σ ( o = 1 to {n}_{o} ) log ( exp ( {s}_{o} ( r ) ) / Σ ( i = 1 to {n}_{o} ) exp ( {s}_{i} ( r ) ) ) \cdot {y}_{o} ( r )$$

Here, yo(⋅) may represent a mask map for instance o, and sᵢ(⋅) may represent a probability map calculated as the opacity map of the ith avatar.

### 3. Monocular Geometry Loss

Monocular geometric loss, which improves reconstruction quality in areas with limited or no texture, may include depth loss and/or normal loss.

### a) Depth Loss (Scale-Translation Invariant)

Depth loss may be defined as following mathematical equation 7.

$$[ Mathematical equation 7 ]$$

$${L}_{d} = {min}_{( w , q )} Σ ( r ∈ R ) {‖ ( ω \cdot d ( r ) + q ) - d \hat{} ( r ) ‖}_{{2}^{2}}$$

Here, w and q may represent the scale and translation parameters estimated for each RGB frame. d\hat{ } may represent the observed depth map, and d may represent the synthesized depth map.

### b) Normal Loss

Normal loss may be defined as following mathematical equation 8.

$$[ Mathematical equation 8 ]$$

$${{L}_{n} = Σ ( r ∈ R ) {‖ n ( r ) - n \hat{} ( r ) ‖}_{1} + ‖ 1 - n ( r ) \cdot n \hat{} r ) ‖}_{1}$$

n\hat{ } may represent the observed normal map, and n may represent the synthesized normal map.

The normalization term of the present disclosure may include the basic normalization term of 2D Gaussian splatting and/or the additional normalization term of GART.

The basic regularization term for 2D Gaussian splatting may include a normal consistency term and/or a depth-concentrated term.

### 4-1. Normal Consistency Term

The normal consistency term may constrain the normal direction of the Gaussian to match the gradient of the depth map. The normal consistency term may be defined as following mathematical equation 9.

$$[ Mathematical equation 9 ]$$

$${L}_{m} = Σ ( i ) {‖ ni - ∇ d ( xi ) ‖}_{2}$$

Here, nᵢ is the normal vector of the ith Gaussian, and ∇d(xi) may represent the depth map gradient at location xi.

### 4-2. Depth Concentration Term

The depth concentration term may induce the depth values of Gaussians intersecting with a ray to be similar. The depth concentration term may be defined as following mathematical equation 10.

$$[ Mathematical equation 10 ]$$

$${L}_{r d} = Σ ( r ∈ R ) std ( \{ {d}_{i} \vert i ∈ V ( r ) \} )$$

Here, std( ) may mean the standard deviation function, and V(r) may mean the set of Gaussians (or Gaussian splats) that intersect ray r.

According to one embodiment of the present disclosure, the additional regularization term of GART can be used by integrating the following KNN-based smoothing term and spatial distortion regularization term.

### 4-3. KNN-Based Smoothing Term

The KNN-based smoothing term may constrain the attributes of adjacent Gaussians to prevent abrupt changes. The KNN-based smoothing term may be defined as following mathematical equation 11.

$$[ Mathematical equation 11 ]$$

$$LSTD = Σ ( attr ∈ \{ R , s , η , f , \hat{w} , w ∼ \} ) λ\_attr * STD ( i ∈ KNN ( {μ}_{i} ) ) ( {attr}_{i} )$$

Here, attr may represent attributes including rotation (R), scale(s), opacity (\eta), feature (f), spatial distortion (ŵ, \tilde{w}), etc., and KNN (μi) may represent the k-nearest neighbors of the i-th Gaussian center.

### 4-4. Spatial Distortion Regularization Term

The spatial distortion regularization term may prevent abrupt changes in the skinning weights and maintain an appropriate size. The spatial distortion regularization term may be expressed as following mathematical equation 12.

$$[ Mathematical equation 12 ]$$

$$Lnorm = λ\_ \hat{w} {‖ Δ wi ‖}_{2} + λ\_w ∼ {‖ w ∼ ( μ i ) ‖}_{2} + λ\_s ‖ si ‖ ∞$$

Here, Δwᵢ may represent the learnable spatial distortion variation, w˜(μi) may represent the skinning weight for the latent sample, and sᵢ may represent the scale of the Gaussian.

The KNN-based smoothing term and spatial distortion regularization term may be ultimately integrated as shown in mathematical equation 13 below.

$$[ Mathematical equation 13 ]$$

$${L}_{reg} = ( 1 / N ) Σ ( i = 1 to N ) ( L\_STDi + L\_normi )$$

The regularization term discussed above may improve the geometric consistency of the surface and the accuracy of depth information, while maintaining the physical validity of the overall representation.

According to one embodiment of the present disclosure, the final loss function (Total Loss) may be expressed as following mathematical equation 14.

$$[ Mathematical equation 14 ]$$

$$L = {λ}_{c} * {L}_{c} + {λ}_{so} * {L}_{s o} + {λ}_{d} * {L}_{d} + {λ}_{n} * {L}_{n} + {λ}_{rn} * {L}_{rn} + {λ}_{r d} * {L}_{r d} + {λ}_{r e g} * {L}_{r e g}$$

The final loss function may be configured to include the four loss terms Lc, Lso, Ld, Ln described above, and three regularization terms Lrn, Lrd, Lreg.

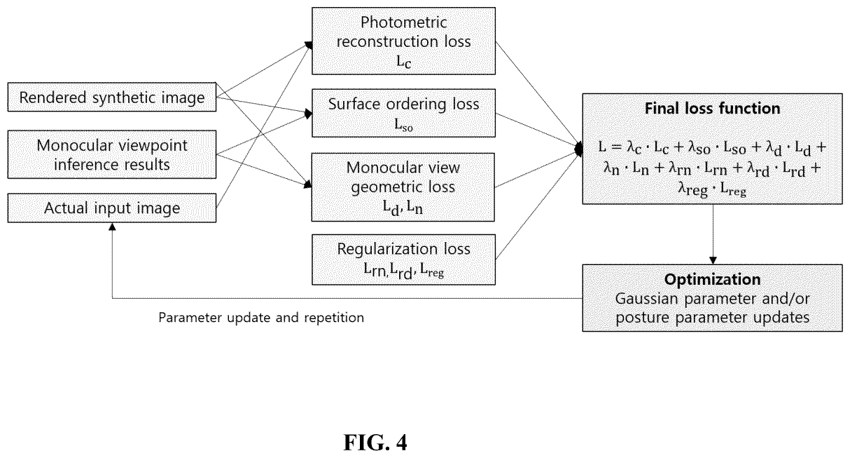

FIG. 4 is a diagram schematically illustrating a learning process of a rendered image according to one embodiment of the present disclosure.

Referring to FIG. 4, the photometric reconstruction loss can be calculated using the rendered synthetic image and the actual input image, the surface alignment loss can be calculated using the rendered synthetic image and the monocular view information inference result, and the monocular view geometric loss can be calculated using the rendered synthetic image and the monocular view inference result.

Referring to FIG. 4, a final loss function including a loss term and/or a regular term derived from the calculation of a detailed loss function may be derived, and optimization of Gaussian parameters and/or posture parameters of a Gaussian model can be performed using the final loss function.

Referring to FIG. 1, final human object avatar meshes for each human object is reconstructed based on a result of the learning S170.

According to one embodiment of the present disclosure, final 3D avatar meshes be generated based on learned representations. Complete avatars with high-quality geometry and/or texture may be reconstructed.

The method of the present disclosure enables effective 3D reconstruction even in sparse multi-view environments (e.g., 4-8 viewpoints).

To this end, one embodiment of the present disclosure may introduce a spherical sampling method centered on a human object. Specifically, a virtual sphere centered on the object is established, and a predetermined number of virtual viewpoints (e.g., 100) are sampled from this sphere, thereby supplementing information about areas not observed from the limited real viewpoints.

Additionally, in one embodiment of the present disclosure, a monocular viewpoint information inference model may be used to supplement depth information. Accurate shape reconstruction may be achieved even in areas not observed due to sparse multi-viewpoints or areas lacking texture, using a depth map obtained through monocular viewpoint geometric inference at each viewpoint.

The method of the present disclosure enables efficient processing that may be learned in about 10 minutes on a single GPU by providing fast learning and rendering speed through view-space clipping in the process of fast grid-based differentiable rendering and object-specific parallel rendering of Gaussian compared to general neural network volume rendering methods. This allows for the provision of high-quality avatar reconstruction technology that can be immediately utilized in the production of realistic content such as AR/VR, and has the effect of being applicable to various application fields that require real-time multi-user interaction.

In particular, the method of the present disclosure takes an approach of separating and processing each human object into an independent layer by applying a human object layer rendering method, and optimizing the geometric relationship between human objects in a differentiable manner. According to the method of the present disclosure, by combining a differentiable layer rendering method and a surface ordering loss function, geometric information of a rear object can still be learned through adaptive blending weights based on depth differences, and by utilizing segmentation information to mitigate surface penetration effects, modeling of natural inter-object geometric relationships can be achieved.

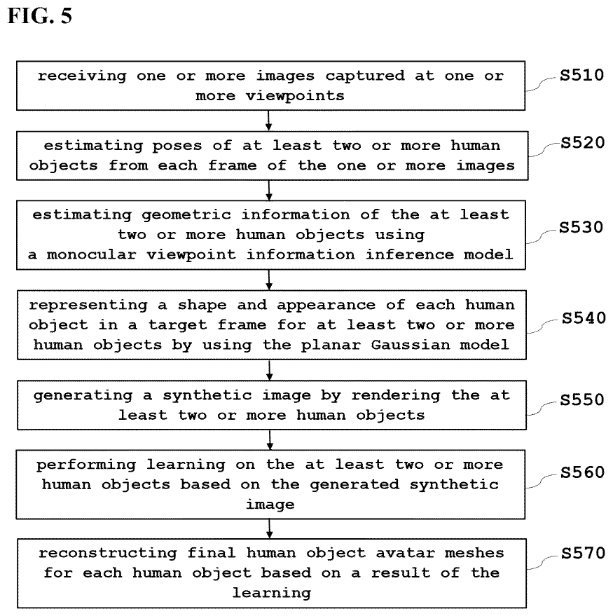

FIG. 5 is a flowchart of a method for reconstructing multi-person object avatars based on a planar Gaussian model according to one embodiment of the present disclosure.

Referring to FIG. 5, one or more images captured at one or more viewpoints are received S510. This can be understood as the same process as S110 of FIG. 1, and thus, a detailed description thereof will be omitted to avoid duplication.

Referring to FIG. 5, poses of at least two human objects are estimated from each frame of the one or more images S520. This can be understood as the same process as S120 of FIG. 1, and thus, a detailed description thereof will be omitted to avoid duplication.

Referring to FIG. 5, geometric information of the at least two human objects is estimated using a monocular viewpoint information inference model S530. This can be understood as the same process as S130 of FIG. 1, and thus, a detailed description thereof will be omitted to avoid duplication.

Meanwhile, according to one embodiment of the present disclosure, further refinement of the estimated poses of at least two human objects may be performed. As described with reference to FIG. 1, a detailed description thereof will be omitted to avoid duplication.

Referring to FIG. 5, a shape and appearance of each human object in a target frame for at least two human objects is represented by using the planar Gaussian model S540. This can be understood as the same process as S140 of FIG. 1, and thus, a detailed description thereof will be omitted to avoid duplication.

Referring to FIG. 5, a synthetic image is generated by rendering the at least two human objects S550.

This disclosure proposes two rendering methods (a first rendering method and a second rendering method). Below, the second rendering method of this disclosure will be examined in detail.

### Person Multi-Object Rendering Method

For each frame, the representation method of a human object is transformed to match the pose of the frame at a specific viewpoint. Afterwards, at least two human objects may then be volume-rendered together to create a synthetic image. The synthetic image may include depth, normal, and/or color images. A model can be trained to ensure that the generated synthetic image matches the information inferred from a monocular viewpoint.

More specifically, the person multi-object rendering method is as follows.

According to one embodiment of the present disclosure, the Gaussian models of an avatar transformed in a regular space can be ordered depth-wise and projected into image space to render the final avatar appearance. The specific formula may be expressed as mathematical equation 15 below.

$$[ Mathematical equation 15 ]$$

$$p ( r ) = {Σ}_{( i = 1 )} p\_i * α\_i * G\_i ( {u\_}_{i} ( r ) ) * {Π}_{( j = 1 to i - 1 )} ( 1 - α\_j * G\_j ( u\_j ( r ) ) )$$

Here, r may represent a pixel ray, and i may represent an index of a planar Gaussian model. p_i∈{c_i(r), n_i, d_i} may represent attributes of the planar Gaussian model. The attributes may include color, normal, and/or depth. α_i may represent the opacity of the planar Gaussian model. G_i may represent the spatial density distribution of the ith planar Gaussian model, and u_i(r) may represent the intersection of the ray and the model.

The spatial density distribution Gᵢ of each planar Gaussian model may be calculated as in mathematical equation 16.

$$[ Mathematical equation 16 ]$$

$$G\_i ( u ) = exp ( - 1 / 2 * u \hat{} T * S\_i \hat{} ( - T ) S\_i \hat{} ( - 1 ) * u )$$

Here, i may represent the index of the planar Gaussian model, u may represent the local 2D coordinates (u, v) of the ith planar Gaussian model, and Sᵢ may represent the scale matrix of the ith Gaussian.

Referring to FIG. 5, performing learning on the at least two human objects based on the generated synthetic image S560.

According to one embodiment of the present disclosure, learning may be performed for at least two human objects based on a rendered synthetic image.

For example, learning may be performed by applying a penalty for luminance differences.

For example, learning may be performed using inference results from a monocular view information inference model. The inference results may include instance segmentation using the monocular view information inference model and/or geometric information estimated using the monocular view information inference model.

In the present disclosure, the loss function may be configured to include a loss term as discussed with reference to Equations 5 to 8 and/or a regularization term as discussed with reference to Equations 9 to 13. In this case, as in Equation 14 described above, the overall loss function may be defined as a weighted sum of these. Since this is the same as discussed with reference to S150, a detailed description thereof will be omitted here to avoid duplication.

Referring to FIG. 5, final human object avatar meshes for each human object is reconstructed based on a result of the learning S570.

According to one embodiment of the present disclosure, final 3D avatar meshes be generated based on learned representations. Complete avatars with high-quality geometry and/or texture may be reconstructed.

The method of the present disclosure enables effective 3D reconstruction even in sparse multi-view environments (e.g., 4-8 viewpoints).

To this end, one embodiment of the present disclosure may introduce a spherical sampling method centered on a human object. Specifically, a virtual sphere centered on the object is established, and a predetermined number of virtual viewpoints (e.g., 100) are sampled from this sphere, thereby supplementing information about areas not observed from the limited real viewpoints.

Additionally, in one embodiment of the present disclosure, a monocular viewpoint information inference model may be used to supplement depth information. Accurate shape reconstruction may be achieved even in areas not observed due to sparse multi-viewpoints or areas lacking texture, using a depth map obtained through monocular viewpoint geometric inference at each viewpoint.

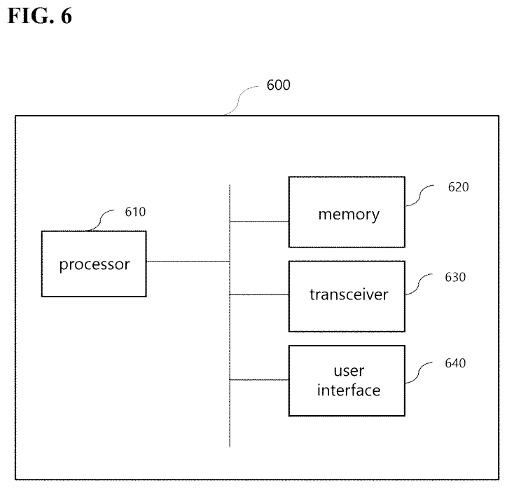

FIG. 6 is a block diagram of an apparatus for reconstructing multi-person object avatars based on a planar Gaussian model according to one embodiment of the present disclosure.

The apparatus 600 may include one or more processors 610, one or more memories 620, one or more transceivers 630, one or more user interfaces 640, etc. The memory 620 may be included in the processor 610 or may be configured separately. The memory 620 may store instructions that cause the apparatus 600 to perform operations when executed by the processor 610. The transceiver 630 may transmit and/or receive signals, data, etc. that the apparatus 600 exchanges with other entities. The user interface 640 may receive an input of the user for the apparatus 600 or provide an output of the apparatus 600 to the user. Among the components of the apparatus 600, components other than the processor 610 and the memory 620 may not be included in some cases, and other components not shown in FIG. 6 may be included in the apparatus 600.

The processor 610 may be configured to cause the apparatus 600 to perform operations of the device according to various examples of the present disclosure. Although not illustrated in FIG. 6, the processor 610 may be configured as a set of modules each performing a function. The modules may be configured in the form of hardware and/or software.

The processor 610 of the apparatus 600 can generally support/perform operations such as receiving one or more images captured at one or more viewpoints, estimating poses of at least two human objects from each frame of the one or more images, estimating geometric information of the at least two human objects using a monocular viewpoint information inference model, representing a shape and appearance of each human object in a target frame for at least two human objects by using the planar Gaussian model, generating a synthetic image by rendering the at least two human objects, performing learning on the at least two human objects based on the generated synthetic image, and reconstructing final human object avatar meshes for each human object based on a result of the learning.

Here, the synthetic image is generated by blending human object layers for the at least two human objects, and the human object layers are individually generated for the at least two human objects ordered based on depth values.

Alternatively, the processor 610 of the apparatus 600 can generally support/perform operations such as receiving one or more images captured at one or more viewpoints, estimating poses of at least two human objects from each frame of the one or more images, estimating geometric information of the at least two human objects using a monocular viewpoint information inference model, representing a shape and appearance of each human object in a target frame for at least two human objects by using the planar Gaussian model, generating a synthetic image by rendering the at least two human objects, performing learning on the at least two human objects based on the generated synthetic image, and reconstructing final human object avatar meshes for each human object based on a result of the learning.

Here, the synthetic image is generated by projecting the at least two human objects ordered based on depth values into a single image space.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for reconstructing multi-person object avatars based on a planar Gaussian model, comprising:
receiving one or more images captured at one or more viewpoints;
estimating poses of at least two human objects from each frame of the one or more images;
estimating geometric information of the at least two human objects using a monocular viewpoint information inference model;
representing a shape and appearance of each human object in a target frame for at least two human objects by using the planar Gaussian model;
generating a synthetic image by rendering the at least two human objects;
performing learning on the at least two human objects based on the generated synthetic image; and
reconstructing final human object avatar meshes for each human object based on a result of the learning,
wherein the synthetic image is generated by blending human object layers for the at least two human objects, and
wherein the human object layers are individually generated for the at least two human objects ordered based on depth values.

2. The method of claim 1, wherein the synthetic image is generated based on at least one map of alpha map, a color map, a depth map, and a normal map for each human object.

3. The method of claim 1, wherein the blending is performed by considering a blending weight, and
wherein the blending weight is determined based on the alpha value of the human object and the depth difference between the human objects.

4. The method of claim 1, wherein the at least two human objects are positioned in close proximity, semi-transparent rendering is performed.

5. The method of claim 1, wherein the learning is performed by adaptively adjusting a predetermined hyperparameter,
wherein the predetermined hyperparameter is a parameter that controls sensitivity to depth differences between human objects.

6. The method of claim 1, wherein the learning is performed based on a loss function including at least one of a photometric reconstruction loss term, a surface ordering loss term, and a monocular view geometric loss term,
wherein the monocular view geometric loss term includes at least one of a depth loss term and a normal loss term.

7. The method of claim 6, wherein the learning is performed based on a loss function that further includes at least one of a basic regularization term and a GART additional regularization term,
wherein the GART additional regularization term is a regularization term that integrates a KNN-based smoothing term and a spatial distortion regularization term.

8. The method of claim 1, wherein the shape in the target frame is represented using the planar Gaussian model,
wherein the planar Gaussian model is represented as a distribution function of at least one of a rotation, center position, and scale matrix.

9. The method of claim 1, wherein the appearance in the target frame is represented via linear blending skinning,
wherein the linear blending skinning is a technique for defining a transformation between a reference space in which the poses of the at least two human objects are modeled and a target space to which movement is applied.

10. The method of claim 1, wherein the method further includes refining the estimated poses of the at least two human objects.

11. The method of claim 1, wherein a number of the received one or more images is N (4≤N≤8).

12. An apparatus for reconstructing multi-person object avatars based on a planar Gaussian model, comprising:
one or more transceivers;
one or more memories; and
one or more processors,
the one or more processors being configured to:
receive one or more images captured at one or more viewpoints,
estimate poses of at least two human objects from each frame of the one or more images,
estimate geometric information of the at least two human objects using a monocular viewpoint information inference model,
represent a shape and appearance of each human object in a target frame for at least two human objects by using the planar Gaussian model,
generate a synthetic image by rendering the at least two human objects,
perform learning on the at least two human objects based on the generated synthetic image, and
reconstruct final human object avatar meshes for the at least two human objects based on a result of the learning,
wherein the synthetic image is generated by blending human object layers for the at least two human objects, and
wherein the human object layers are individually generated for the at least two human objects ordered based on depth values.

13. A method for reconstructing multi-person object avatars based on a planar Gaussian model, comprising:
receiving one or more images captured at one or more viewpoints;
estimating poses of at least two human objects from each frame of the one or more images;
estimating geometric information of the at least two human objects using a monocular viewpoint information inference model;
representing a shape and appearance of each human object in a target frame for at least two human objects by using the planar Gaussian model;
generating a synthetic image by rendering the at least two human objects;
performing learning on the at least two human objects based on the generated synthetic image; and
reconstructing final human object avatar meshes for each human object based on a result of the learning,
wherein the synthetic image is generated by projecting the at least two human objects ordered based on depth values into a single image space.

14. The method of claim 13, wherein the learning is performed based on a loss function including at least one of a photometric reconstruction loss term, a surface ordering loss term, and a monocular view geometric loss term,
wherein the monocular view geometric loss term includes at least one of a depth loss term and a normal loss term.

15. The method of claim 14, wherein the learning is performed based on a loss function that further includes at least one of a basic regularization term and a GART additional regularization term,
wherein the GART additional regularization term is a regularization term that integrates a KNN-based smoothing term and a spatial distortion regularization term.

16. The method of claim 13, wherein the shape in the target frame is represented using the planar Gaussian model,
wherein the planar Gaussian model is represented as a distribution function of at least one of a rotation, center position, and scale matrix.

17. The method of claim 13, wherein the appearance in the target frame is represented via linear blending skinning,
wherein the linear blending skinning is a technique for defining a transformation between a reference space in which the poses of the at least two human objects are modeled and a target space to which movement is applied.

18. The method of claim 13, wherein the method further includes refining the estimated poses of the at least two human objects.

19. The method of claim 13, wherein a number of the received one or more images is N (4≤N≤8).

20. An apparatus for reconstructing multi-person object avatars based on a planar Gaussian model according to the present disclosure, comprising:
receive one or more images captured at one or more viewpoints,
estimate poses of at least two human objects from each frame of the one or more images,
estimate geometric information of the at least two human objects using a monocular viewpoint information inference model,
represent a shape and appearance of each human object in a target frame for at least two human objects by using the planar Gaussian model,
generate a synthetic image by rendering the at least two human objects,
perform learning on the at least two human objects based on the generated synthetic image, and
reconstruct final human object avatar meshes for each human object based on a result of the learning,
wherein the synthetic image is generated by projecting the at least two human objects ordered based on depth values into a single image space.
